(19) United States
(12) Patent Application Publication
(10) Pub. No.: US 2025/0300194 A1
(43) Pub. Date: Sep. 25, 2025

(54) INTER-CONNECTOR AND ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/830,760

(22) Filed: Sep. 11, 2024

Related U.S. Application Data
(63) Continuation of application No. PCT/JP2024/010779, filed on Mar. 19, 2024.

(51) Int. Cl. H01M 8/0254; H01M 8/0208; H01M 8/0228; H01M 8/12

(52) U.S. Cl. CPC H01M 8/0254; H01M 8/0208; H01M 8/0228; H01M 2008/1293

(57) ABSTRACT

The present inter-connector includes a body and a plurality of oxide layers. The body includes a first principal surface, a second principal surface, and a plurality of protrusions. The second principal surface faces an opposite side from the first principal surface. The protrusions are provided on the first principal surface. Each of the plurality of oxide layers is disposed on a lateral surface of each of the plurality of protrusions. At least one of the plurality of oxide layers has a thickness distributed to induce the inter-connector to be warped to bulge at the body toward the second principal surface.

### CROSS-REFERENCE TO RELATED APPLICATIONS

This is a continuation of PCT/JP2024/010779, filed Mar. 19, 2024, the entire contents of which are hereby incorporated by reference.

### TECHNICAL FIELD

The present invention relates to an inter-connector and an electrochemical cell.

### BACKGROUND ART

An electrochemical cell such as an electrolytic cell, a fuel cell, or so forth includes a cell body, a support substrate, and an inter-connector. For example, an electrochemical cell disclosed in WO2018/181926 A1 is configured such that a support substrate and an inter-connector compose a gas channel, while a cell body is supported on the support substrate. A plurality of electrochemical cells, each of which is configured as described above, are laminated in the form of a cell stack.

### SUMMARY OF THE INVENTION

### Technical Problems

When a given one of the electrochemical cells is laminated on another one in the form of a cell stack, if protrusions and recesses are provided on the cell body of the another one disposed below the inter-connector of the given one, the inter-connector presses the protrusions; hence, it is concerned that the cell body is undesirably damaged or broken by load concentration onto the protrusions provided thereon.

It is an object of the present invention to provide an inter-connector, whereby damage or breakage of a cell body can be inhibited.

### Solution to Problems

An inter-connector according to a first aspect includes a body and a plurality of oxide layers. The body includes a first principal surface, a second principal surface, and a plurality of protrusions. The second principal surface faces an opposite side from the first principal surface. The plurality of protrusions are provided on the first principal surface. Each of the plurality of oxide layers is disposed on a lateral surface of each of the plurality of protrusions. At least one of the plurality of oxide layers has a thickness distributed to induce the inter-connector to be warped to bulge at the body toward the second principal surface.

According to the configuration, the inter-connector is warped to bulge toward the second principal surface by the distribution of thickness in each of the at least one oxide layer. Because of this, when a given one of electrochemical cells, including the inter-connector, is laminated on another one in the form of a cell stack, it is made possible to absorb a drawback caused due to protrusions and recesses provided on a cell body of the another one disposed below the inter-connector of the given one. As a result, load concentration on the protrusions of the cell body can be inhibited, whereby damage or breakage of the cell body can be inhibited.

An inter-connector according to a second aspect relates to the inter-connector according to the first aspect and is configured as follows. The plurality of protrusions are disposed away from each other at intervals in a gas flow direction. The plurality of protrusions include a first protrusion and a second protrusion. The first protrusion is disposed farthest upstream in the gas flow direction. The second protrusion is disposed farthest downstream in the gas flow direction. The each of the plurality of oxide layers includes an upstream portion facing upstream and a downstream portion facing downstream. One disposed on a lateral surface of the first protrusion among the plurality of oxide layers has a thickness distributed to be smaller in the upstream portion than in the downstream portion.

An inter-connector according to a third aspect relates to the inter-connector according to the second aspect and is configured as follows. One disposed on a lateral surface of the second protrusion among the plurality of oxide layers has a thickness distributed to be larger in the upstream portion than in the downstream portion.

An inter-connector according to a fourth aspect relates to the inter-connector according to the second or third aspect and is configured as follows. The plurality of protrusions include a third protrusion. The third protrusion is disposed in a middle region between the first protrusion and the second protrusion in the gas flow direction. A difference in thickness between the upstream portion and the downstream portion is larger in the one disposed on the lateral surface of the first protrusion among the plurality of oxide layers than in one disposed on a lateral surface of the third protrusion among the plurality of oxide layers.

An inter-connector according to a fifth aspect relates to the inter-connector according to any of the second to fourth aspects and is configured as follows. The plurality of protrusions include a third protrusion. The third protrusion is disposed in a middle region between the first protrusion and the second protrusion in the gas flow direction. One disposed on a lateral surface of the third protrusion among the plurality of oxide layers is larger in thickness than not only the one disposed on the lateral surface of the first protrusion among the plurality of oxide layers but also one disposed on a lateral surface of the second protrusion among the plurality of oxide layers.

An inter-connector according to a sixth aspect relates to the inter-connector according to the first aspect and is configured as follows. The plurality of protrusions extend in a gas flow direction. The plurality of protrusions are disposed away from each other at intervals in a first direction oriented orthogonal to the gas flow direction. The plurality of protrusions include a first protrusion and a second protrusion. The first and second protrusions are disposed farthest outward in the first direction. The each of the plurality of oxide layers includes an outer portion facing outward in the first direction and an inner portion facing inward in the first direction. One disposed on a lateral surface of the first protrusion among the plurality of oxide layers has a thickness distributed to be smaller in the outer portion than in the inner portion.

An inter-connector according to a seventh aspect relates to the inter-connector according to the sixth aspect and is configured as follows. One disposed on a lateral surface of the second protrusion among the plurality of oxide layers has a thickness distributed to be smaller in the outer portion than in the inner portion.

An inter-connector according to an eighth aspect relates to the inter-connector according to the sixth or seventh aspect and is configured as follows. The plurality of protrusions include a third protrusion. The third protrusion is disposed in a middle region between the first protrusion and the second protrusion in the first direction. A difference in thickness between the outer portion and the inner portion is larger in the one disposed on the lateral surface of the first protrusion among the plurality of oxide layers than in one disposed on a lateral surface of the third protrusion among the plurality of oxide layers.

An inter-connector according to a ninth aspect relates to the inter-connector according to any of the sixth to eighth aspects and is configured as follows. The plurality of protrusions include a third protrusion. The third protrusion is disposed in a middle region between the first protrusion and the second protrusion in the first direction. One disposed on a lateral surface of the third protrusion among the plurality of oxide layers is larger in thickness than the one disposed on the lateral surface of the first protrusion among the plurality of oxide layers. The one disposed on the lateral surface of the third protrusion among the plurality of oxide layers is larger in thickness than one disposed on a lateral surface of the second protrusion among the plurality of oxide layers.

An inter-connector according to a tenth aspect relates to the inter-connector according to any of the first to ninth aspects and is configured as follows. The body is made of an alloy containing chromium. The each of the plurality of oxide layers contains chromium as a primary component.

An inter-connector according to an eleventh aspect relates to the inter-connector according to any of the first to tenth aspects and is configured as follows. The each of the plurality of oxide layers is smaller in thermal expansion coefficient than the body.

An electrochemical cell according to a twelfth aspect includes the inter-connector recited in any of the first to eleventh aspects, a support substrate, and a cell body. The support substrate is attached to the inter-connector. The cell body is disposed on the support substrate.

An electrochemical cell according to a thirteenth aspect relates to the electrochemical cell according to the twelfth aspect and is configured as follows. The each of the plurality of oxide layers is smaller in thickness than the cell body.

### Advantageous Effects of Invention

According to the present invention, damage or breakage of a cell body can be inhibited.

### BRIEF DESCRIPTION OF THE DRAWINGS

FIG. 1 is a plan view of an electrolytic cell.

FIG. 2 is a cross-sectional view of the electrolytic cell taken along line II-II in FIG. 1.

FIG. 3 is a plan view of an inter-connector.

FIG. 4 is an enlarged cross-sectional view of a first protrusion.

FIG. 5 is a cross-sectional view of the first protrusion taken along line V-V in FIG. 4.

FIG. 6 is an enlarged cross-sectional view of a second protrusion.

FIG. 7 is a cross-sectional view of the second protrusion taken along line VII-VII in FIG. 6.

FIG. 8 is an enlarged cross-sectional view of a third protrusion.

FIG. 9 is a cross-sectional view of the third protrusion taken along line IX-IX in FIG. 8.

FIG. 10 is an enlarged cross-sectional view showing a direction in which the inter-connector is warped at the first protrusion and the surroundings thereof.

FIG. 11 is an enlarged cross-sectional view showing a direction in which the inter-connector is warped at the second protrusion and the surroundings thereof.

FIG. 12 is a plan view of an inter-connector according to a modification.

FIG. 13 is a cross-sectional view of the inter-connector taken along line XIII-XIII in FIG. 12.

FIG. 14 is a cross-sectional view of the inter-connector taken along line XIV-XIV in FIG. 12.

FIG. 15 is a cross-sectional view of the inter-connector taken along line XV-XV in FIG. 12.

FIG. 16 is an enlarged cross-sectional view showing a direction in which the inter-connector is warped at the first protrusion and the surroundings thereof.

FIG. 17 is an enlarged cross-sectional view showing a direction in which the inter-connector is warped at the second protrusion and the surroundings thereof.

### DESCRIPTION OF EMBODIMENTS

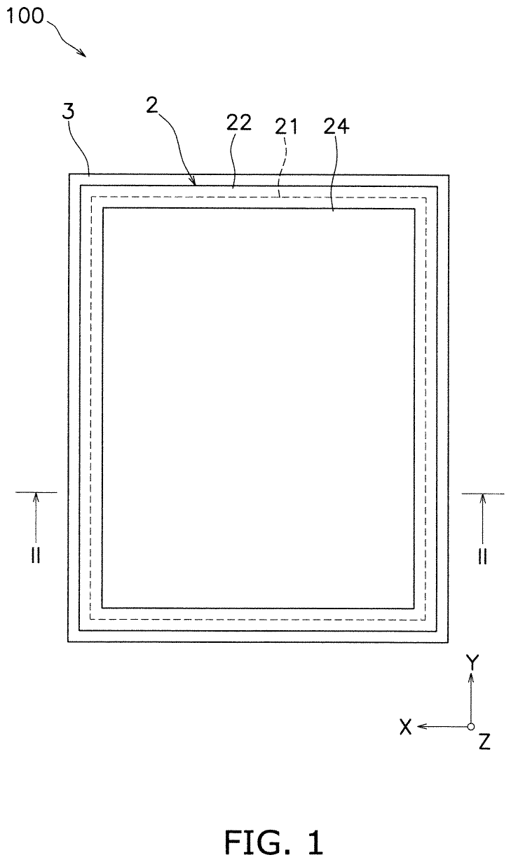

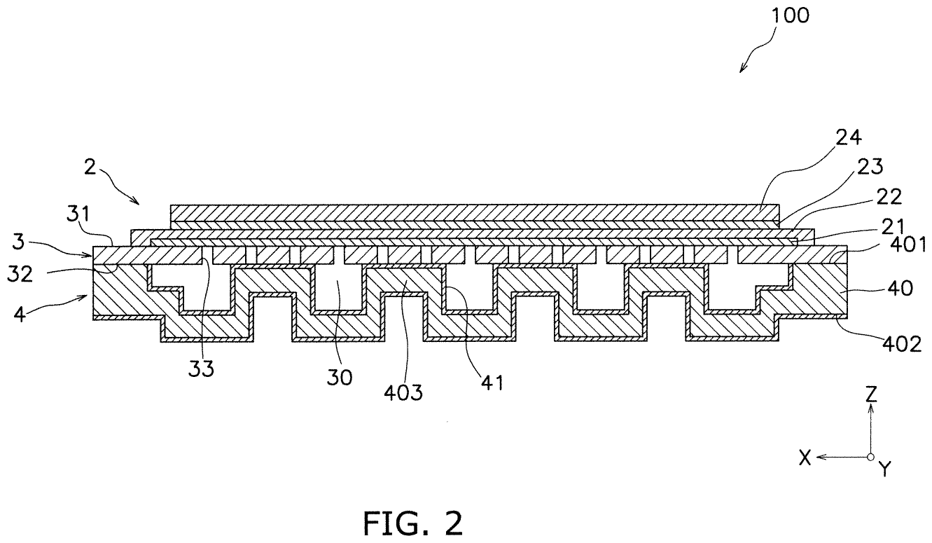

An electrolytic cell 100 (exemplary electrochemical cell) according to the present preferred embodiment will be hereinafter explained with reference to drawings. It should be noted that in the present preferred embodiment, explanation will be made with a solid oxide electrolytic cell (SOEC) as an example of the electrolytic cell 100. FIG. 1 is a plan view of the electrolytic cell 100. FIG. 2 is a cross-sectional view of the electrolytic cell 100 taken along line II-II in FIG. 1.

### Electrolytic Cell

As shown in FIGS. 1 and 2, the electrolytic cell 100 is made in shape of a plate extending in an X-axis direction and a Y-axis direction. In the present preferred embodiment, when seen in a plan view along a Z-axis direction perpendicular to both the X-axis and Y-axis directions, the electrolytic cell 100 is made in shape of a rectangle elongated in the Y-axis direction. However, the electrolytic cell 100 is not particularly limited in planar shape; hence, the planar shape thereof may be a polygon, an ellipse, a circle, or so forth other than the rectangle. It should be noted that the Z-axis direction means the thickness direction of the electrolytic cell 100, a cell body 2, a support substrate 3, and an inter-connector 4.

As shown in FIGS. 1 and 2, the electrolytic cell 100 includes the cell body 2, the support substrate 3, and the inter-connector 4.

### Cell Body

The cell body 2 is disposed on the support substrate 3. The cell body 2 is supported by the support substrate 3. The cell body 2 is disposed on the support substrate 3 to cover a plurality of through holes 33 (to be described). The cell body 2 includes a hydrogen electrode 21 (cathode), an electrolyte 22, a reaction preventing layer 23, and an oxygen electrode 24 (anode).

The hydrogen electrode 21, the electrolyte 22, the reaction preventing layer 23, and the oxygen electrode 24 are laminated in this order from the support substrate 3 side along the Z-axis direction. The hydrogen electrode 21, the electrolyte 22, and the oxygen electrode 24 are essential components; however, the reaction preventing layer 23 is a component provided on an arbitrary basis.

### Hydrogen Electrode

The hydrogen electrode 21 is disposed on a first principal surface 31 of the support substrate 3. The hydrogen electrode 21 is supplied with raw material gas via each of the through holes 33 of the support substrate 3. The raw material gas contains at least water vapor (H₂O). The hydrogen electrode 21 generates H₂ with electrolytic reactions.

When the raw material gas contains only H₂O, the hydrogen electrode 21 generates H₂ from the raw material gas by electrochemical reactions of water electrolysis expressed in the following formula (1).

Hydrogen Electrode 21:

H₂O+2e⁻→H₂+O²⁻ (1)

When the raw material gas contains CO₂ in addition to H₂O, the hydrogen electrode 21 generates H₂, CO, and O²⁻ from the raw material gas by electrochemical reactions of co-electrolysis expressed in the following formulae (2), (3), and (4).

Hydrogen Electrode 21:

CO₂+H₂O+4e⁻→CO+H₂+2O²⁻ (2)

Electrochemical Reaction of H₂O:

H₂O+2e⁻→H₂+O²⁻ (3)

Electrochemical Reaction of CO₂:

CO₂+2e⁻→CO+O²⁻ (4)

H₂ generated in the hydrogen electrode 21 flows out via each of the through holes 33 of the support substrate 3 to an internal space 30 (to be described).

The hydrogen electrode 21 is a porous body with electronic conductivity. The hydrogen electrode 21 contains nickel (Ni). In co-electrolysis, Ni not only functions as an electron transmitter but also functions as a thermal catalyst that maintains a gas composition appropriate for methanation, FT (Fischer-Tropsch) synthesis, and so forth by promoting thermal reactions between H₂ to be generated and CO₂ contained in the raw material gas. During operating the electrolytic cell 100, Ni contained in the hydrogen electrode 21 basically exists in a state of metal (Ni) but may exist in part in a state of nickel oxide (NiO).

The hydrogen electrode 21 may contain an ionic conductive material. For example, the following can be used as the ionic conductive material: one selected from the group of yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr) (Cr, Mn)O₃, (La, Sr)TiO₃, Sr₂(Fe, Mo)₂O₆, (La, Sr)VO₃, and (La, Sr)FeO₃, a mixed material obtained by a combination of two or more of the group, or so forth.

The hydrogen electrode 21 is not particularly limited in thickness, and hence, can be set to have a thickness of, for instance, greater than or equal to 1 μm and less than or equal to 100 μm. The hydrogen electrode 21 is not particularly limited in thermal expansion coefficient, and hence, can be set to have a thermal expansion coefficient of, for instance, greater than or equal to 12×10⁻⁶/° C. and less than or equal to 20×10⁻⁶/° C.

The hydrogen electrode 21 is not particularly limited in method of formation, and hence, can be formed by any of the methods such as firing, spray coating (thermal spraying, aerosol deposition, aerosol gas deposition, powder jet deposition, particle jet deposition, cold spraying, etc.), PVD (spattering, pulse laser deposition, etc.), and CVD.

### Electrolyte

The electrolyte 22 is formed on the hydrogen electrode 21. The electrolyte 22 is disposed between the hydrogen electrode 21 and the oxygen electrode 24. In the present preferred embodiment, the electrolyte 22 is connected to both the hydrogen electrode 21 and the reaction preventing layer 23, while being interposed therebetween.

The electrolyte 22 not only covers the hydrogen electrode 21 but also covers a region, exposed without being covered with the hydrogen electrode 21, on the first principal surface 31 of the support substrate 3.

The electrolyte 22 is a dense body with oxide ionic conductivity. The electrolyte 22 transmits O²⁻, generated in the hydrogen electrode 21, to the oxygen electrode 24 side. The electrolyte 22 is made of an oxide ionic conductive material. The electrolyte 22 can be made of, for instance, YSZ, GDC, ScSZ, SDC, LSGM (lanthanum gallate), or so forth but is preferably made of YSZ.

The electrolyte 22 is not particularly limited in thickness, and hence, can be set to have a thickness of, for instance, greater than or equal to 1 μm and less than or equal to 100 μm. The electrolyte 22 is not particularly limited in thermal expansion coefficient, and hence, can be set to have a thermal expansion coefficient of, for instance, greater than or equal to 10×10⁻⁶/° C. and less than or equal to 12×10⁻⁶/° C.

The electrolyte 22 is not particularly limited in method of formation, and hence, can be formed by any of the methods such as firing, spray coating, PVD, and CVD.

### Reaction Preventing Layer

The reaction preventing layer 23 is disposed between the electrolyte 22 and the oxygen electrode 24. The reaction preventing layer 23 is disposed on the opposite side of the electrolyte 22 from the side on which the hydrogen electrode 21 is disposed, with reference to the electrolyte 22. The reaction preventing layer 23 inhibits a layer with high electric resistance from being formed by reactions between the element of which the electrolyte 22 is made and the element of which the oxygen electrode 24 is made.

The reaction preventing layer 23 is made of an oxide ionic conductive material. The reaction preventing layer 23 can be made of GDC, SDC, or so forth.

The reaction preventing layer 23 is not particularly limited in porosity, and hence, can be set to have a porosity of, for instance, greater than or equal to 0.1% and less than or equal to 50%. The reaction preventing layer 23 is not particularly limited in thickness, and hence, can be set to have a thickness of, for instance, greater than or equal to 1 μm and less than or equal to 50 μm.

The reaction preventing layer 23 is not particularly limited in method of formation, and hence, can be formed by any of the methods such as firing, spray coating, PVD, and CVD.

### Oxygen Electrode

The oxygen electrode 24 is disposed on the opposite side of the electrolyte 22 from the side on which the hydrogen electrode 21 is disposed, with reference to the electrolyte 22. In the present preferred embodiment, the reaction preventing layer 23 is disposed between the electrolyte 22 and the oxygen electrode 24; hence, the oxygen electrode 24 is connected to the reaction preventing layer 23. When the reaction preventing layer 23 is not disposed between the electrolyte 22 and the oxygen electrode 24, the oxygen electrode 24 is connected to the electrolyte 22.

The oxygen electrode 24 generates O₂ from O²⁻ transmitted thereto from the hydrogen electrode 21 via the electrolyte 22 by chemical reactions expressed by the following formula (5).

Oxygen Electrode 24:

2O²⁻→O₂+4e⁻ (5)

The oxygen electrode 24 is a porous body with oxide ionic conductivity and electronic conductivity. The oxygen electrode 24 can be made of, for instance, a composite material composed of an oxide ionic conductive material (GDC, etc.) and at least one selected from the group consisting of (La, Sr) (Co, Fe)O₃, (La, Sr)FeO₃, La (Ni, Fe)O₃, (La, Sr)CoO₃, and (Sm, Sr)CoO₃.

The oxygen electrode 24 is not particularly limited in porosity, and hence, can be set to have a porosity of, for instance, greater than or equal to 20% and less than or equal to 60%. The oxygen electrode 24 is not particularly limited in thickness, and hence, can be set to have a thickness of, for instance, greater than or equal to 1 μm and less than or equal to 100 μm.

The oxygen electrode 24 is not particularly limited in method of formation, and hence, can be formed by any of the methods such as firing, spray coating, PVD, and CVD.

### Support Substrate

As shown in FIG. 2, the support substrate 3 supports the cell body 2. In the present preferred embodiment, the support substrate 3 is made in shape of a plate. Insomuch as the cell body 2 can be supported by the support substrate 3, the support substrate 3 is not particularly limited in thickness, and hence, can be set to have a thickness of, for instance, greater than or equal to 0.1 mm and less than or equal to 2.0 mm.

The raw material gas to be supplied to the cell body 2 and reducing gas (H₂ in the present preferred embodiment) to be generated in the hydrogen electrode 21 flow inside the internal space 30 defined by the support substrate 3 and the inter-connector 4.

The support substrate 3 includes the first principal surface 31, a second principal surface 32, and the plural through holes 33. In the present preferred embodiment, the first principal surface 31 is the upper surface of the support substrate 3, whereas the second principal surface 32 is the lower surface of the support substrate 3. The first principal surface 31 faces the cell body 2. The second principal surface 32 faces the inter-connector 4.

Each of the through holes 33 is configured to cause gas to permeate therethrough. Each through hole 33 penetrates the support substrate 3 from the first principal surface 31 to the second principal surface 32. Each through hole 33 is opened on each of the first and second principal surfaces 31 and 32. Because of this, gas permeates through the support substrate 3 via the through holes 33.

Each through hole 33 is covered with the cell body 2. Specifically, the first principal surface 31-side opening of each through hole 33 is covered with the hydrogen electrode 21. The second principal surface 32-side opening of each through hole 33 is connected to the internal space 30.

The respective through holes 33 can be formed by machining processing (e.g., punching), laser processing, chemical processing (e.g., etching), or so forth.

In the present preferred embodiment, each through hole 33 is shaped straight along the Z-axis direction. However, each through hole 33 may slant with respect to the Z-axis direction; besides or alternatively, each through hole 33 may not be shaped straight. Besides or alternatively, the through holes 33 may continue to each other.

The support substrate 3 is made of an alloy containing Cr (Chromium). Fe—Cr-based alloy steel (stainless steel, etc.), Ni—Cr-based alloy steel, or so forth can be exemplified as the alloy herein described. The support substrate 3 is not particularly limited in content rate of Cr, and hence, can be set to contain Cr at a content rate of greater than or equal to 4 mass % and less than or equal to 30 mass %.

The support substrate 3 may contain Ti (Titanium) and Zr (Zirconium). The support substrate 3 is not particularly limited in content rate of Ti, and hence, can be set to contain Ti at a content rate of greater than or equal to 0.01 mol % and less than or equal to 1.0 mol %. The support substrate 3 is not particularly limited in content rate of Zr, and hence, can be set to contain Zr at a content rate of greater than or equal to 0.01 mol % and less than or equal to 0.4 mol %. The support substrate 3 may contain Ti in the form of TiO₂ (titania) and may contain Zr in the form of ZrO₂ (zirconia).

### Inter-Connector

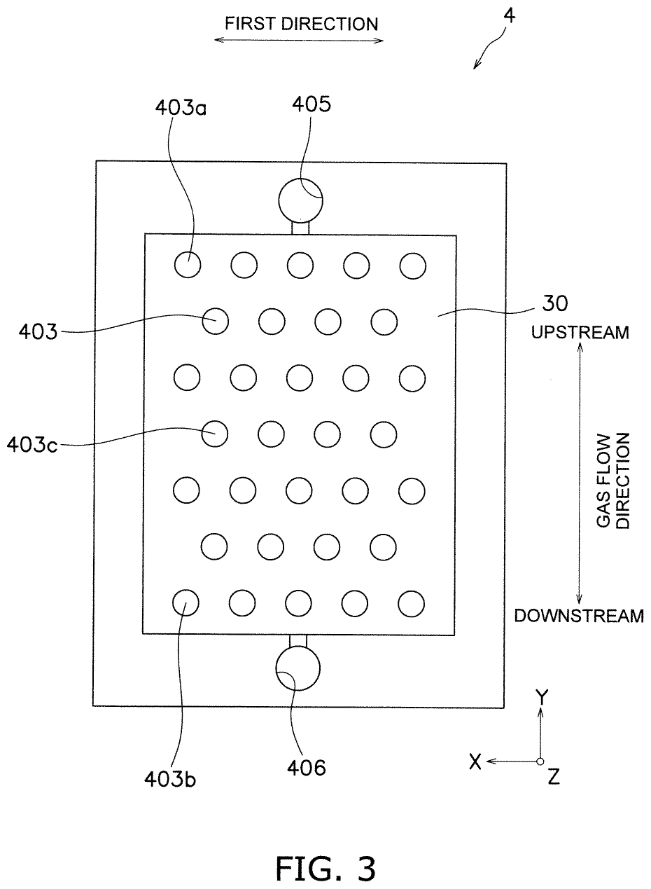

FIG. 3 is a plan view of the inter-connector 4. As shown in FIGS. 2 and 3, the inter-connector 4 is disposed on the same side as the second principal surface 32 of the support substrate 3. The inter-connector 4 is a member for electrically connecting the electrolytic cell 100 to either an external power source or another electrolytic cell. Besides, the inter-connector 4 is configured such that the raw material gas and the gas generated in the hydrogen electrode 21 flow into the internal space 30. In the following explanation, the term “gas flow direction” means a direction oriented from a support hole 405 (to be described) to a discharge hole 406 (to be described). Specifically, the Y-axis direction corresponds to the gas flow direction. On the other hand, the term “first direction” is defined as a direction oriented orthogonal to the gas flow direction. Specifically, the X-axis direction corresponds to the first direction.

The inter-connector 4 is made in shape of a plate. The inter-connector 4 is attached to the support substrate 3. The inter-connector 4 is fixed at the outer peripheral part thereof to the support substrate 3. The inter-connector 4 is fixed to the support substrate 3 by, for instance, welding or bonding. The inter-connector 4 includes a body 49 and a plurality of oxide layers 41.

The body 40 is made in shape of a plate. The body 40 is not particularly limited in thickness, and hence, can be set to have a thickness of, for instance, greater than or equal to 0.1 mm and less than or equal to 2.0 mm. The outer peripheral part of the body 40 protrudes toward the support substrate 3. The outer peripheral part of the body 40 defines the outer circumference of the internal space 30. It should be noted that the outer peripheral part of the body 40 may be provided as a member separated from the body 40.

The body 40 includes a first principal surface 401, a second principal surface 402, a plurality of protrusions 403, the supply hole 405, and the discharge hole 406. The first principal surface 401 is a surface facing the support substrate 3. The second principal surface 402 is opposite from the first principal surface 401. In other words, the second principal surface 402 faces the opposite side of a direction in which the first principal surface 401 faces. In the present preferred embodiment, the first principal surface 401 is the upper surface of the body 40, whereas the second principal surface 402 is the lower surface of the body 40.

The supply hole 405 and the discharge hole 406 are communicated with the internal space 30. The supply hole 405 penetrates the inter-connector 4 in the Z-axis direction. The raw material gas, supplied to the electrolytic cell 100 from an external gas supply source, flows through the supply hole 405 in the Z-axis direction. The raw material gas is supplied to the interior of the internal space 30 via the supply hole 405.

The discharge hole 406 penetrates the inter-connector 4 in the Z-axis direction. H₂, which is generated in the hydrogen electrode 21 and flows through the internal space 30, is discharged to the outside via the discharge hole 406 and is recovered on the outside.

Each of the protrusions 403 is provided on the first principal surface 401 of the body 40. Each protrusion 403 protrudes toward the support substrate 3. Each protrusion 403 is disposed inside the internal space 30. Each protrusion 403 is not particularly limited in height, and hence, can be set to have a height of, for instance, greater than or equal to 0.1 mm and less than or equal to 2.0 mm. Each protrusion 403 is made in shape of a column or cylinder.

As shown in FIG. 3, the protrusions 403 are disposed away from each other at intervals in the gas flow direction. Besides, the protrusions 403 are disposed away from each other at intervals in the first direction oriented orthogonal to the gas flow direction as well. Specifically, the protrusions 403 are aligned in a staggered shape. The respective protrusions 403 can be formed by processing the inter-connector 4 by stamping, cutting, etching, or so forth.

Each protrusion 403 is larger than each through hole 33 in a plan view. Because of this, in the plan view, two or more of the plural through holes 33 overlap with each protrusion 403.

The plural protrusions 403 include a plurality of first protrusions 403a, a plurality of second protrusions 403b, and a plurality of third protrusions 403c. It should be noted that in the present preferred embodiment, the plural protrusions 403 include five first protrusions 403a, five second protrusions 403b, and four third protrusions 403c.

The first protrusions 403a are disposed farthest upstream in the gas flow direction. In other words, the first protrusions 403a are those disposed on the upper end in FIG. 3 among the plural protrusions 403. The first protrusions 403a are aligned in the first direction.

The second protrusions 403b are disposed farthest downstream in the gas flow direction. In other words, the second protrusions 403b are those disposed on the lower end in FIG. 3 among the plural protrusions 403. The second protrusions 403b are aligned in the first direction.

The third protrusions 403c are disposed in a middle region between the first protrusions 403a and the second protrusions 403b in the gas flow direction. In other words, the third protrusions 403c are those disposed closest to the midpoints of the first protrusions 403a and the second protrusions 403b in the gas flow direction among the plural protrusions 403. The third protrusions 403c are aligned in the first direction.

As shown in FIG. 2, the body 40 is made of an alloy containing Cr. Fe—Cr-based alloy steel, Ni—Cr-based alloy steel, or so forth can be exemplified as the alloy herein described. The body 40 is not particularly limited in content rate of Cr, and hence, can be set to contain Cr at a content rate of greater than or equal to 4 mass % and less than or equal to 30 mass %. The body 40 may be identical in composition to or different in composition from the support substrate 3.

Each of the oxide layers 41 is disposed on the lateral surface of each protrusion 403. Each oxide layer 41 is disposed on the entire lateral surface of each protrusion 403. In other words, each oxide layer 41 has an annular shape in a plan view. It should be noted that an oxide layer may be disposed on the first principal surface 401. In this case, the oxide layers 41 are connected therethrough to each other. An oxide layer may be disposed on the distal end surface of each protrusion 403. It should be noted that an oxide layer is not disposed on the outer peripheral part of the first principal surface 401, but alternatively, may be disposed thereon.

Each oxide layer 41 is different in thermal expansion coefficient from the body 40. In the present preferred embodiment, each oxide layer 41 is smaller in thermal expansion coefficient than the body 40. Each oxide layer 41 is made of an oxide containing Cr as a primary component (hereinafter abbreviated as “Cr oxide”). Accordingly, during manufacturing or operating the electrolytic cell 100, Cr can be inhibited from diffusing from the support substrate 3 and the body 40 to each oxide layer 41. Besides, even if Cr diffuses from the support substrate 3 and the body 40 to each oxide layer 41, the diffused Cr is not so much as affecting the composition of each oxide layer 41; hence, deterioration in strength of each oxide layer 41 can be inhibited as well.

It should be noted that in the present preferred embodiment, “the Cr oxide, of which each oxide layer 41 is made, contains Cr as the primary component” means that Cr is the highest in content rate among metallic elements of the Cr oxide when the composition of the Cr oxide is analyzed by an energy dispersive spectrometer (EDS). The Cr oxide is not particularly limited in content rate of Cr among the metallic elements, and hence, can be set to contain Cr at a content rate of, for instance, greater than or equal to 20 mol % and less than or equal to 100 mol %.

The Cr oxide, of which each oxide layer 41 is made, preferably contains Cr among the metallic elements thereof at a content rate of greater than or equal to 50 mol %. Accordingly, Cr contained in the support substrate 3 and the body 40 can be remarkably inhibited from diffusing to each oxide layer 41.

The Cr oxide, of which each oxide layer 41 is made, is preferably composed of at least either chromium oxide or chromium manganese oxide. The oxides herein described have properties that Cr is especially unlikely to diffuse; hence, each oxide layer 41 can be thereby enhanced in durability.

Cr₂O₃ or so forth can be exemplified as the chromium oxide. MnCr₂O₄ (spinel), Mn_{1.5}Cr_{1.5}O₄ (spinel), or so forth can be exemplified as the chromium manganese oxide.

The Cr oxide, of which each oxide layer 41 is made, is preferably crystalline. Because of this, even if the electrolytic cell 100 is operated for a long period of time, it is made possible to avoid occurrence of such a situation that the Cr oxide transitions from a non-crystalline phase to a crystalline phase, whereby each oxide layer 41 is undesirably damaged or broken.

The Cr oxide, of which each oxide layer 41 is made, preferably has either a spinel crystal structure or a corundum crystal structure. The crystal structures herein described are high in symmetry; hence, each oxide layer 41 can be thereby enhanced in endurance against thermal stress.

Each oxide layer 41 can be formed by applying a paste containing the Cr oxide onto the lateral surface of each protrusion 403, and then, by conducting a thermal treatment. Conditions for the thermal treatment can be arbitrarily set but the following can be set as exemplary conditions for the thermal treatment: a temperature of greater than or equal to 600° C. and less than or equal to 1100° C. and a duration of greater than or equal to 0.5 hours and less than or equal to 24 hours.

Each oxide layer 41 is smaller in thickness than the cell body 2. Each oxide layer 41 can be set to have a thickness of, for instance, greater than or equal to 0.1 μm and less than or equal to 20 μm.

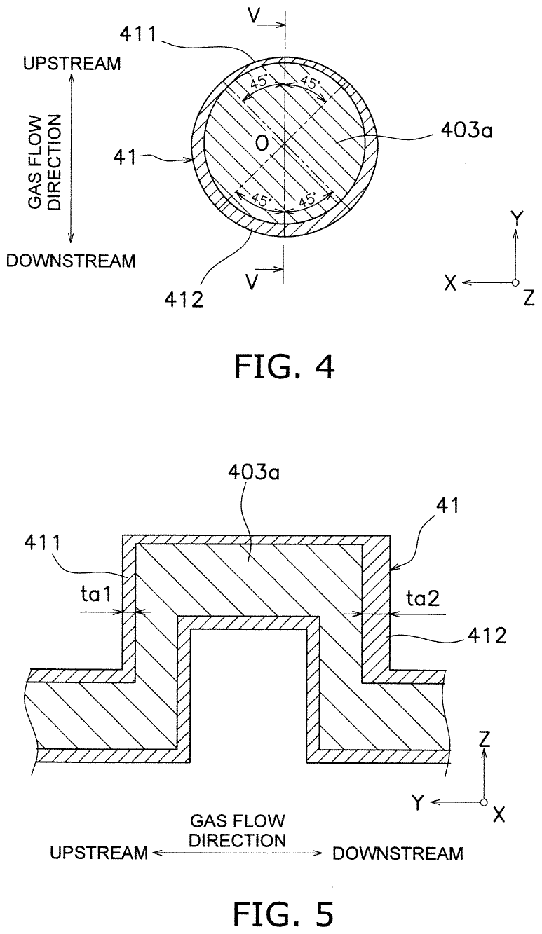

FIG. 4 is an enlarged cross-sectional view of each first protrusion 403a as seen in the thickness direction, whereas FIG. 5 is a cross-sectional view of each first protrusion 403a taken along line V-V in FIG. 4. As shown in FIGS. 4 and 5, each oxide layer 41 includes an upstream portion 411 and a downstream portion 412. The upstream portion 411 is a portion facing upstream in each oxide layer 41. The downstream portion 412 is a portion facing downstream in each oxide layer 41. For example, where the upper side in FIG. 4 is defined as the upstream side, while the lower side in FIG. 4 is defined as the downstream side, the upstream portion 411 refers to a portion located within an angular range of ±45 degrees about an imaginary line that extends directly upward from the center (O) of each protrusion 403 to indicate an angle of 0 degrees. On the other hand, the downstream portion 412 refers to a portion located within an angular range of ±45 degrees about an imaginary line that extends directly downward from the center O of each protrusion 403 to indicate an angle of 0 degrees.

At least one of the plural oxide layers 41 has a thickness distributed to induce the inter-connector 4 to be warped to bulge at the body 40 toward the second principal surface 402.

When described in detail, first, in the oxide layer 41 disposed on the lateral surface of each first protrusion 403a, the thickness (ta1) of the upstream portion 411 is smaller than the thickness (ta2) of the downstream portion 412. For example, in the oxide layer 41 disposed on the lateral surface of each first protrusion 403a, the average of values of the thickness ta1 of the upstream portion 411 is smaller than that of values of the thickness ta2 of the downstream portion 412.

In the oxide layer 41 disposed on the lateral surface of at least one of the first protrusions 403a, a ratio of the thickness ta1 to the thickness ta2 (ta1/ta2) can be set to be less than or equal to 0.83. Besides, the ratio (ta1/ta2) can be set to be greater than or equal to 0.1

In the oxide layer 41 disposed on the lateral surface of each first protrusion 403a, the thickness ta1 of the upstream portion 411 and the thickness ta2 of the downstream portion 412 can be measured as follows. First, in order to create such a cross section as shown in FIG. 5 for each of the first protrusions 403a, each first protrusion 403a is cut by an imaginary plane that is oriented along the gas flow direction (the Y-axis direction) to pass through the center of each first protrusion 403a. Then, in each of the cross sections for the first protrusions 403a, the upstream portion 411 and the downstream portion 412 are scanned (photographed) by a scanning electron microscopy (SEM) at a magnification (of 200-fold to 20000-fold) suitable for measurement of thickness. It should be noted that scanning is made in the vicinity of the middle of each first protrusion 403a in a height direction.

Subsequently, the thickness ta1 of the upstream portion 411 and the thickness ta2 of the downstream portion 412 are measured in each of the images scanned by the SEM. It should be noted that the thickness ta1 of the upstream portion 411 and the thickness ta2 of the downstream portion 412 are measured in the center of each first protrusion 403a in the height direction.

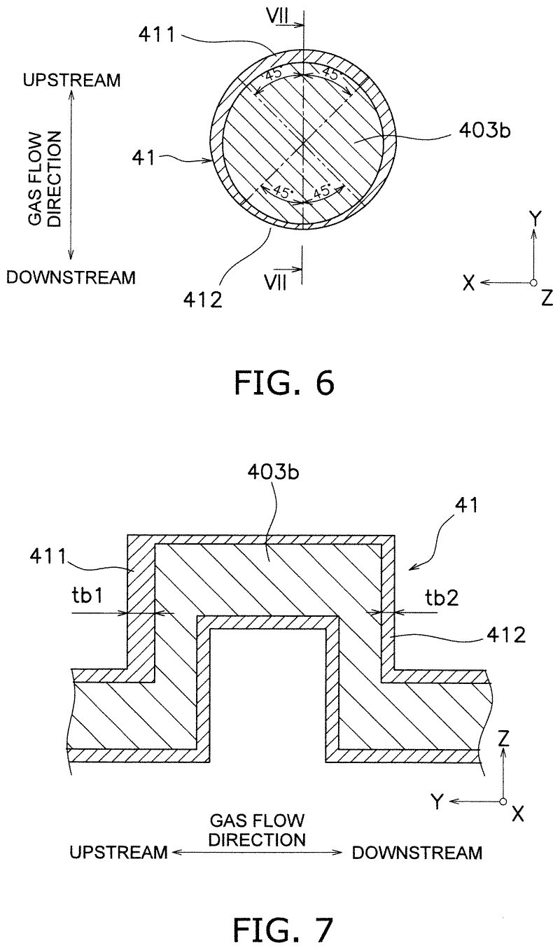

FIG. 6 is an enlarged cross-sectional view of each second protrusion 403b as seen in the thickness direction, whereas FIG. 7 is a cross-sectional view of each second protrusion 403b taken along line VII-VII in FIG. 6. As shown in FIGS. 6 and 7, in the oxide layer 41 disposed on the lateral surface of each second protrusion 403b, the thickness (tb1) of the upstream portion 411 is larger than the thickness (tb2) of the downstream portion 412. For example, in the oxide layer 41 disposed on the lateral surface of each second protrusion 403b, the average of values of the thickness tb1 of the upstream portion 411 is larger than that of values of the thickness tb2 of the downstream portion 412.

In the oxide layer 41 disposed on the lateral surface of at least one of the second protrusions 403b, a ratio of the thickness tb1 to the thickness tb2 (tb1/tb2) can be set to be greater than or equal to 1.2. Besides, the ratio (tb1/tb2) can be set to be less than or equal to 10.

In the oxide layer 41 disposed on the lateral surface of each second protrusion 403b, the thickness tb1 of the upstream portion 411 and the thickness tb2 of the downstream portion 412 can be measured as follows. First, in order to create such a cross section as shown in FIG. 7 for each of the second protrusions 403b, each second protrusion 403b is cut by an imaginary plane that is oriented along the gas flow direction (the Y-axis direction) to pass through the center of each second protrusion 403b. Then, in each of the cross sections for the second protrusions 403b, the upstream portion 411 and the downstream portion 412 are scanned (photographed) by the scanning electron microscopy (SEM) at a magnification (of 200-fold to 20000-fold) suitable for measurement of thickness. It should be noted that scanning is made in the vicinity of the middle of each second protrusion 403b in the height direction.

Subsequently, the thickness tb1 of the upstream portion 411 and the thickness tb2 of the downstream portion 412 are measured in each of the images scanned by the SEM. It should be noted that the thickness tb1 of the upstream portion 411 and the thickness tb2 of the downstream portion 412 are measured in the center of each second protrusion 403a in the height direction.

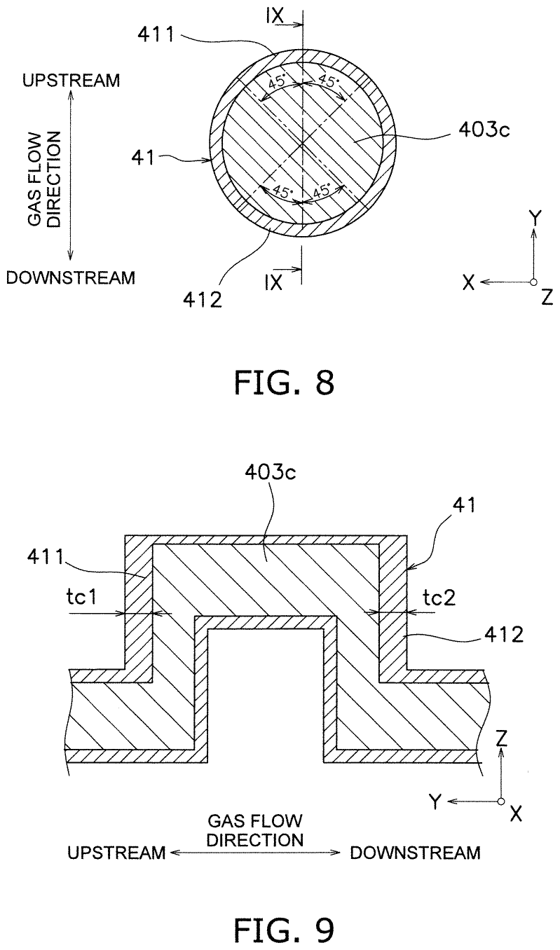

FIG. 8 is an enlarged cross-sectional view of each third protrusion 403c as seen in the thickness direction, whereas FIG. 9 is a cross-sectional view of each third protrusion 403c taken along line IX-IX in FIG. 8. As shown in FIGS. 8 and 9, in the oxide layer 41 disposed on the lateral surface of each third protrusion 403c, the thickness (tc1) of the upstream portion 411 is approximately equal to the thickness (tc2) of the downstream portion 412. For example, in the oxide layer 41 disposed on the lateral surface of each third protrusion 403c, the average of values of the thickness tc1 of the upstream portion 411 is approximately equal to that of values of the thickness tc2 of the downstream portion 412.

In the oxide layer 41 disposed on the lateral surface of at least one of the third protrusions 403c, a ratio of the thickness tc1 to the thickness tc2 (tc1/tc2) can be set to be greater than or equal to 0.83 and less than or equal to 1.2.

Difference in thickness (tc1-tc2) between the upstream portion 411 and the downstream portion 412 in the oxide layer 41 disposed on the lateral surface of each third protrusion 403c is smaller than difference in thickness (ta1-ta2) between the upstream portion 411 and the downstream portion 412 in the oxide layer 41 disposed on the lateral surface of each first protrusion 403a. Besides, difference in thickness (tc1-tc2) between the upstream portion 411 and the downstream portion 412 in the oxide layer 41 disposed on the lateral surface of each third protrusion 403c is smaller than difference in thickness (tb1-tb2) between the upstream portion 411 and the downstream portion 412 in the oxide layer 41 disposed on the lateral surface of each second protrusion 403b. Here, difference in thickness between the upstream portion 411 and the downstream portion 412 is expressed by an absolute value.

In the oxide layer 41 disposed on the lateral surface of each third protrusion 403c, the thickness tc1 of the upstream portion 411 and the thickness tc2 of the downstream portion 412 can be measured as follows. First, in order to create such a cross section as shown in FIG. 9 for each of the third protrusions 403c, each third protrusion 403c is cut by an imaginary plane that passes through the center of each third protrusion 403c along the gas flow direction (the Y-axis direction). Then, in each of the cross sections for the third protrusions 403c, the upstream portion 411 and the downstream portion 412 are scanned (photographed) by the scanning electron microscopy (SEM) at a magnification (of 200-fold to 20000-fold) suitable for measurement of thickness. It should be noted that scanning is made in the vicinity of the middle of each third protrusion 403c in the height direction.

Subsequently, the thickness tc1 of the upstream portion 411 and the thickness tc2 of the downstream portion 412 are measured in each of the images scanned by the SEM. It should be noted that the thickness tc1 of the upstream portion 411 and the thickness tc2 of the downstream portion 412 are measured in the center of each third protrusion 403c in the height direction.

The oxide layer 41 disposed on the lateral surface of each third protrusion 403c is larger in thickness than that disposed on the lateral surface of each first protrusion 403a. For example, the average of values of the thickness of the oxide layer 41 disposed on the lateral surface of each third protrusion 403c is larger than that of values of the thickness of the oxide layer 41 disposed on the lateral surface of each first protrusion 403a. Besides, the oxide layer 41 disposed on the lateral surface of each third protrusion 403c is larger in thickness than that disposed on the lateral surface of each second protrusion 403b. For example, the average of values of the thickness of the oxide layer 41 disposed on the lateral surface of each third protrusion 403c is larger than that of values of the thickness of the oxide layer 41 disposed on the lateral surface of each second protrusion 403b. Here, the thickness of the oxide layer 41 can be set as the average of the thickness of the upstream portion 411 and that of the downstream portion 412.

In the oxide layer 41 disposed on the lateral surface of each of the protrusions 403 disposed between the first protrusions 403a and the third protrusions 403c, the upstream portion 411 is preferably smaller in thickness than the downstream portion 412. Besides, in the oxide layer 41 disposed on the lateral surface of each of the protrusions 403 disposed between the second protrusions 403b and the third protrusions 403c, the upstream portion 411 is preferably larger in thickness than the downstream portion 412. Difference in thickness between the upstream portion 411 and the downstream portion 412 is preferably reduced with proximity to the third protrusions 403c.

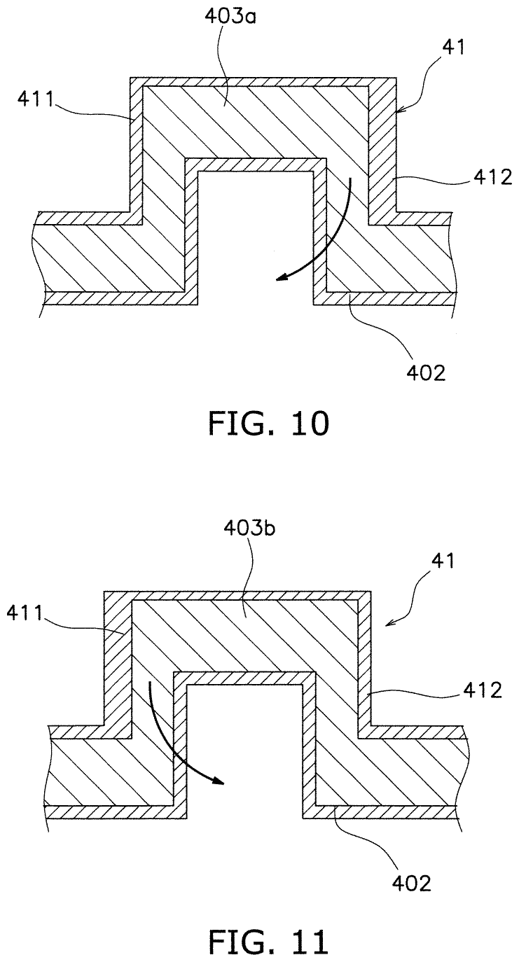

In the inter-connector 4 configured as described above, the downstream portion 412 is larger in thickness than the upstream portion 411 in the oxide layer 41 disposed on the lateral surface of each first protrusion 403a. Because of this, when the oxide layers 41 are reduced in temperature to the room temperature after formed, as indicated by an arrow in FIG. 10, a thermal stress is generated in each of regions provided with the first protrusions 403 in the inter-connector 4, whereby the inter-connector 4 is induced to be warped to bulge toward the second principal surface 402.

On the other hand, the upstream portion 411 is larger in thickness than the downstream portion 412 in the oxide layer 41 disposed on the lateral surface of each second protrusion 403b. Because of this, when the oxide layers 41 are reduced in temperature to the room temperature after formed, as indicated by an arrow in FIG. 11, a thermal stress is generated in each of regions provided with the second protrusions 403b in the inter-connector 4, whereby the inter-connector 4 is induced to be warped to bulge toward the second principal surface 402.

As described above, the inter-connector 4 is warped to bulge toward the second principal surface 402; hence, when the electrochemical cell 100 is laminated on another electrochemical cell in the form of a cell stack, even if protrusions and recesses are provided on the cell body of the electrochemical cell disposed below the inter-connector 4, it is made possible to absorb a drawback caused due to the protrusions and recesses.

### Modifications

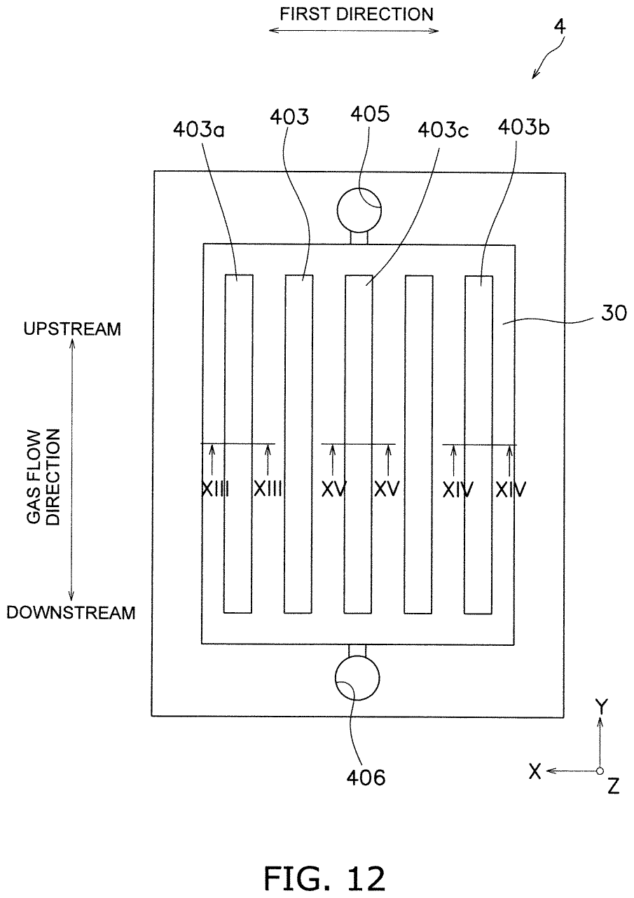

One preferred embodiment of the present invention has been explained above. However, the present invention is not limited to this, and a variety of changes can be made without departing from the gist of the present invention.
(a) In the preferred embodiment described above, each protrusion 403 has a circular shape in the plan view; however, each protrusion 403 is not limited in shape to this. For example, as shown in FIG. 12, each protrusion 403 may have a rectangular shape in the plan view. Besides, each protrusion 403 may be elongated in the gas flow direction. The protrusions 403 are disposed away from each other at intervals in the first direction.

The plural protrusions 403 include a first protrusion 403a, a second protrusion 403b, and a third protrusion 403c. The first and second protrusions 403a and 403b are those disposed farthest outward in the first direction among the plural protrusions 403. The remainder other than the first and second protrusions 403a and 403b among the plural protrusions 403 are disposed between the first and second protrusions 403a and 403b in the first direction.

The third protrusion 403c is disposed in a middle region between the first and second protrusions 403a and 403b in the first direction. In other words, the third protrusion 403c is the one disposed closest to the midpoint of the first and second protrusions 403a and 403b in the first direction among the plural protrusions 403.

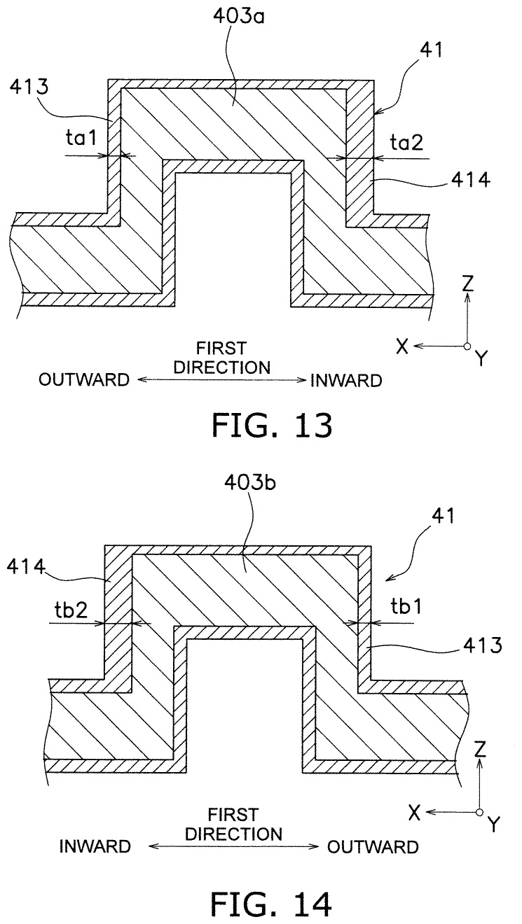

FIG. 13 is a cross-sectional view of the inter-connector 4 taken along line XIII-XIII in FIG. 12. As shown in FIG. 13, each oxide layer 41 includes an outer portion 413 and an inner portion 414. The outer portion 413 is a portion facing outward in the first direction. On the other hand, the inner portion 414 is a portion facing inward in the first direction. In other words, the inner portion 414 faces the center of the inter-connector 4 in the first direction.

In the oxide layer 41 disposed on the lateral surface of the first protrusion 403a, the thickness (ta1) of the outer portion 413 is set to be smaller than the thickness (ta2) of the inner portion 414. For example, in the oxide layer 41 disposed on the lateral surface of the first protrusion 403a, a ratio of the thickness ta1 to the thickness ta2 (ta1/ta2) can be set to be less than or equal to 0.83. Besides, the ratio (ta1/ta2) can be set to be greater than or equal to 0.1.

Likewise, as shown in FIG. 14, in the oxide layer 41 disposed on the lateral surface of the second protrusion 403b as well, the thickness (tb1) of the outer portion 413 is set to be smaller than the thickness (tb2) of the inner portion 414. For example, in the oxide layer 41 disposed on the lateral surface of the second protrusion 403b, a ratio of the thickness tb1 to the thickness tb2 (tb1/tb2) can be set to be less than or equal to 0.83. Besides, the ratio (tb1/tb2) can be set to be greater than or equal to 0.1.

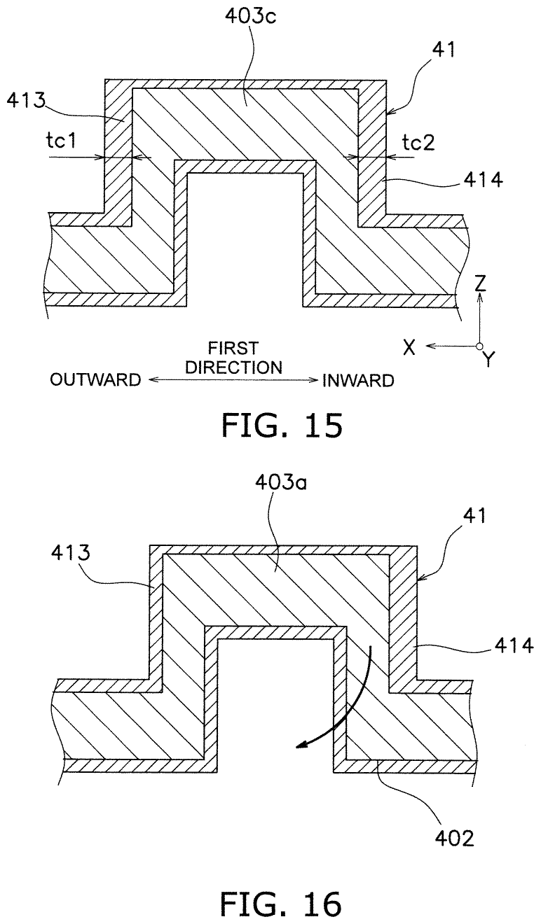

As shown in FIG. 15, in the oxide layer 41 disposed on the lateral surface of the third protrusion 403c, the thickness (tc1) of the outer portion 413 is approximately equal to the thickness (tc2) of the inner portion 414. For example, in the oxide layer 41 disposed on the lateral surface of the third protrusion 403c, a ratio of the thickness tc1 to the thickness tc2 (tc1/tc2) can be set to be greater than or equal to 0.83 and less than or equal to 1.2. It should be noted that in the oxide layer 41 disposed on the lateral surface of the third protrusion 403c, a portion facing the first protrusion 403a refers to the outer portion 413, while a portion facing the second protrusion 403b refers to the inner portion 414, where the third protrusion 403c is disposed in the center of the inter-connector 4 in the first direction.

Difference in thickness between the outer portion 413 and the inner portion 414 (tc1-tc2) in the oxide layer 41 disposed on the lateral surface of the third protrusion 403c is smaller than difference in thickness between the outer portion 413 and the inner portion 414 (ta1-ta2) in the oxide layer 41 disposed on the lateral surface of the first protrusion 403a. Besides, difference in thickness between the outer portion 413 and the inner portion 414 (tc1-tc2) in the oxide layer 41 disposed on the lateral surface of the third protrusion 403c is smaller than difference in thickness between the outer portion 413 and the inner portion 414 (tb1-tb2) in the oxide layer 41 disposed on the lateral surface of the second protrusion 403b. Here, difference in thickness between the outer portion 413 and the inner portion 414 is expressed by an absolute value.

It should be noted that the thickness of each outer portion 413 and that of each inner portion 414 can be measured as follows. First, in order to create three cross sections, the inter-connector 4 is cut by imaginary planes that are oriented along the first direction to pass through the upstream end, the downstream end, and the center of each protrusion 403, respectively. Then, in each of the cross sections, the outer portion 413 and the inner portion 414 in each of the first, second, and third protrusions 403a, 403b, and 403c are scanned (photographed) by the scanning electron microscopy (SEM) at a magnification (of 200-fold to 20000-fold) suitable for measurement of thickness. It should be noted that scanning is made in the vicinity of the middle of each of the first, second, and third protrusions 403a, 403b, and 403c in the height direction.

Subsequently, the thickness of the outer portion 413 and the thickness of the inner portion 414 are measured at each of the upstream end, the downstream end, and the center in the first protrusion 403a in each of the images scanned by the SEM; accordingly, the average of values of the thickness of the outer portion 413 can be set as the thickness ta1 of the outer portion 413 in the first protrusion 403a, while the average of values of the thickness of the inner portion 414 can be set as the thickness ta2 of the inner portion 414 in the first protrusion 403a. Likewise, the respective averages of values of thickness are calculated as the respective thicknesses in the second protrusion 403b and those in the third protrusion 403c.

The oxide layer 41 disposed on the lateral surface of the third protrusion 403c is larger in thickness than that disposed on the lateral surface of the first protrusion 403a. Besides, the oxide layer 41 disposed on the lateral surface of the third protrusion 403c is larger in thickness than that disposed on the lateral surface of the second protrusion 403b. Here, the thickness of the oxide layer 41 can be set as the average of the thickness of the outer portion 413 and that of the inner portion 414.

In the inter-connector 4 configured as described above, the inner portion 414 is larger in thickness than the outer portion 413 in the oxide layer 41 disposed on the lateral surface of the first protrusion 403a. Because of this, when the oxide layer 41 is reduced in temperature to the room temperature after formed, as indicated by an arrow in FIG. 16, a thermal stress is generated in a region provided with the first protrusion 403a in the inter-connector 4, whereby the inter-connector 4 is induced to be warped to bulge toward the second principal surface 402.

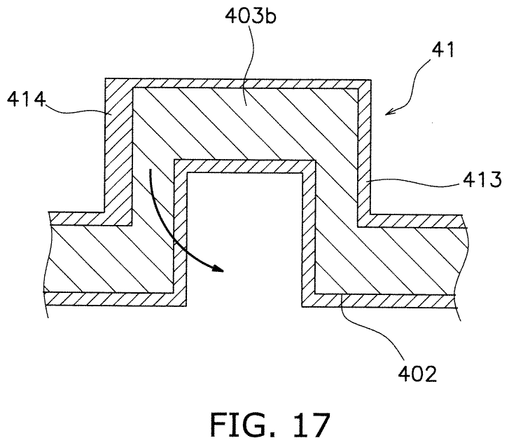

Besides, the inner portion 414 is larger in thickness than the outer portion 413 in the oxide layer 41 disposed on the lateral surface of the second protrusion 403b. Because of this, when the oxide layer 41 is reduced in temperature to the room temperature after formed, as indicated by an arrow in FIG. 17, a thermal stress is generated in a region provided with the second protrusion 403b in the inter-connector 4, whereby the inter-connector 4 is induced to be warped to bulge toward the second principal surface 402.
(b) In the preferred embodiment described above, the oxide layer 41 disposed on the lateral surface of each second protrusion 403b is configured such that the upstream portion 411 is larger in thickness than the downstream portion 412; however, the oxide layer 41 is not limited in configuration to this. For example, the oxide layer 41 disposed on the lateral surface of each second protrusion 403b may be configured such that the upstream portion 411 is approximately equal in thickness to the downstream portion 412.
(c) In the preferred embodiment described above, the electrochemical cell is exemplified by the electrolytic cell but is not limited thereto. The electrochemical cell is a generic term for referring to a device for changing electric energy into chemical energy, in which a pair of electrodes is disposed to generate an electromotive force from entire oxidoreduction reactions, and a device for changing chemical energy into electric energy. Therefore, for instance, a fuel battery, in which oxide ions or protons act as carriers, is also considered as the electrochemical cell.

### REFERENCE SIGNS LIST

100: Electrolytic cell
2: Cell body
3: Support substrate
4: Inter-connector
40: Body
401: First principal surface
402: Second principal surface
403: Protrusion
403a: First protrusion
403b: Second protrusion
403c: Third protrusion
41: Oxide layer
411: Upstream portion
412: Downstream portion
413: Outer portion
414: Inner portion

1. An inter-connector comprising:
a body including a first principal surface, a second principal surface, and a plurality of protrusions, the second principal surface facing an opposite side to the first principal surface, the plurality of protrusions provided on the first principal surface; and
a plurality of oxide layers, each of the plurality of oxide layers disposed on a lateral surface of each of the plurality of protrusions, wherein
at least one of the plurality of oxide layers has a thickness distributed to induce the inter-connector to be warped to bulge at the body toward the second principal surface.

2. The inter-connector according to claim 1, wherein
the plurality of protrusions are disposed away from each other at intervals in a gas flow direction,
the plurality of protrusions include a first protrusion and a second protrusion, the first protrusion disposed farthest upstream in the gas flow direction, the second protrusion disposed farthest downstream in the gas flow direction,
the each of the plurality of oxide layers includes an upstream portion and a downstream portion, the upstream portion facing upstream, the downstream portion facing downstream, and
one disposed on a lateral surface of the first protrusion among the plurality of oxide layers has a thickness distributed to be smaller in the upstream portion than in the downstream portion.

3. The inter-connector according to claim 2, wherein one disposed on a lateral surface of the second protrusion among the plurality of oxide layers has a thickness distributed to be larger in the upstream portion than in the downstream portion.

4. The inter-connector according to claim 2, wherein
the plurality of protrusions include a third protrusion disposed in a middle region between the first protrusion and the second protrusion in the gas flow direction, and
a difference in thickness between the upstream portion and the downstream portion is larger in the one disposed on the lateral surface of the first protrusion among the plurality of oxide layers than in one disposed on a lateral surface of the third protrusion among the plurality of oxide layers.

5. The inter-connector according to claim 2, wherein
the plurality of protrusions includes a third protrusion disposed in a middle region between the first protrusion and the second protrusion in the gas flow direction, and
one disposed on a lateral surface of the third protrusion among the plurality of oxide layers is larger in thickness than not only the one disposed on the lateral surface of the first protrusion among the plurality of oxide layers but also one disposed on a lateral surface of the second protrusion among the plurality of oxide layers.

6. The inter-connector according to claim 1, wherein
the plurality of protrusions extend in a gas flow direction, the plurality of protrusions disposed away from each other at intervals in a first direction oriented orthogonal to the gas flow direction,
the plurality of protrusions include a first protrusion and a second protrusion, the first and second protrusions disposed farthest outward in the first direction,
the each of the plurality of oxide layers includes an outer portion and an inner portion, the outer portion facing outward in the first direction, the inner portion facing inward in the first direction, and
one disposed on a lateral surface of the first protrusion among the plurality of oxide layers has a thickness distributed to be smaller in the outer portion than in the inner portion.

7. The inter-connector according to claim 6, wherein one disposed on a lateral surface of the second protrusion among the plurality of oxide layers has a thickness distributed to be smaller in the outer portion than in the inner portion.

8. The inter-connector according to claim 6, wherein
the plurality of protrusions include a third protrusion disposed in a middle region between the first protrusion and the second protrusion in the first direction, and
a difference in thickness between the outer portion and the inner portion is larger in the one disposed on the lateral surface of the first protrusion among the plurality of oxide layers than in one disposed on a lateral surface of the third protrusion among the plurality of oxide layers.

9. The inter-connector according to claim 6, wherein
the plurality of protrusions include a third protrusion disposed in a middle region between the first protrusion and the second protrusion in the first direction, and
one disposed on a lateral surface of the third protrusion among the plurality of oxide layers is larger in thickness than not only the one disposed on the lateral surface of the first protrusion among the plurality of oxide layers but also one disposed on a lateral surface of the second protrusion among the plurality of oxide layers.

10. The inter-connector according to claim 1, wherein
the body is made of an alloy containing chromium, and
the each of the plurality of oxide layers contains chromium as a primary component.

11. The inter-connector according to claim 1, wherein the each of the plurality of oxide layers is smaller in thermal expansion coefficient than the body.

12. An electrochemical cell comprising:
the inter-connector recited in claim 1;
a support substrate attached to the inter-connector; and
a cell body disposed on the support substrate.

13. The electrochemical cell according to claim 12, wherein the each of the plurality of oxide layers is smaller in thickness than the cell body.
